(19) United States
(12) Patent Application Publication
(10) Pub. No.: US 2004/0095506 A1
(43) Pub. Date: May 20, 2004

(54) Generic, non-mechanical control of cameras in hostile environments

(76) Inventor: David Alan Scott, Cary, NC (US)

Correspondence Address: DAVID ALAN SCOTT, 310 BURGWIN WRIGHT WAY, CARY, NC, 27519, US

(21) Appl. No.: 10/298,988

(22) Filed: Nov. 18, 2002

(51) Int. Cl. H04N 5/225

(52) U.S. Cl. 348/373

(57) ABSTRACT

A controller and protective housing for cameras located in hostile environments that activates camera functions generically and non-mechanically. No knowledge of the physical layout of a camera is necessary to provide programmable access to functions of virtually any digital still camera or digital video camera (42) contained by an air- and/or watertight housing (20). The camera, secured to the inside of the housing via an attachment mechanism (40), has its various functions invoked by way of activators (58). The activators relay requests to a digital controller (36) that initiates and manages instructions sent to the camera through the camera's own communications channels.

### FEDERALLY SPONSORED RESEARCH

Not Applicable

### SEQUENCE LISTING OR PROGRAM

Not applicable

### BACKGROUND—FIELD OF INVENTION

This invention relates to the generic, non-mechanical control of imaging systems, such as still cameras and video cameras, when these imaging systems are used in hostile environments.

### BACKGROUND—DESCRIPTION OF PRIOR ART

Cameras used in hostile environments are no different from those used to take pictures in non-hostile environments (a “hostile environment” can be defined as any environment containing hazardous elements in which, if exposed, a camera would fail to perform properly; for example, a camera used to take pictures underwater or in a burning building, etc.). The key difference is that, in a hostile environment, a protective housing keeps the environment at bay.

At present, sealed containers for imaging systems (“housings”) are designed only for a specific imaging system and use specific attachments for controlling the system inside the housing. For example:

(i) in U.S. Pat. No. 5,508,766, Boyd and Greene describe a water-resistant housing using a cantilevered shutter release device, a mechanical way of actuating the shutter release button. This approach requires an intimate knowledge of the system under control (the camera) and requires relatively tight tolerances to make sure the device lines up and stays lined up during use.

(ii) In U.S. Pat. No. 4,281,343, Monteiro describes an underwater video camera housing with a video camera control mechanism that extends from outside the housing to the inside to control the camera via a mechanical attachment. This type of mechanical system is difficult to control and is prone to failure during the rigors of use (for example, while scuba diving).

(iii) In U.S. Pat. No. 5,694,621, Dowe, et al, describe a non-mechanical (magnetic) apparatus outside the housing for actuating a mechanical device within the housing, notably, a thumbwheel rotationally coupled with a film spool. It is this mechanical device within the housing that controls the imaging system in use, specifically, the winding of the film. This design works well for mechanically actuating a film spool, but doesn't work well for other imaging system controls and suffers from the same tight tolerances necessary for other mechanical systems.

Most commercial housings today are designed to work with only one camera. These housings are designed to tightly fit the camera inside and have mechanical protrusions within the housing for activating the buttons (and other controls) physically present on the outside of the camera. These protrusions line up exactly with the buttons on a specific model of camera. In an apparent effort to avoid this, Hopmeyer, in U.S. Pat. No. 5,669,020, describes an underwater housing with interchangeable back members designed to allow mechanical access to buttons and other controls mounted on the top and rear of various cameras. This has the unfortunate side-effect of requiring the operator to stock multiple ‘back member’ pieces for each camera the operator wishes to control. It also requires the manufacturer to go through the costly process of fabricating a new ‘back member’, each year as the camera manufacturers make slight modifications to the design of their cameras. This approach amounts to having several housings instead of one.

In addition to the challenges presented by mechanical coupling, all of the inventions described above require advance knowledge of the physical layout of the controls of the camera. This has two unfortunate side effects: (i) the manufacturer of such a housing must engage in the costly process of retooling the production machinery each year to accommodate design changes introduced by the camera manufacturer and (ii) the operator must purchase a new housing along with any new camera purchase.

In addition to the previously described methods of activation, various methods have also been devised for providing a physical housing for a camera. For example:

(i) In U.S. Pat. Nos. 5,778,259 and 6,064,824, Rink describes housings for underwater cameras that are sealed, but have cables that protrude through the case and connect to a recording device. The protruding cables, though, significantly reduce mobility for the operator and make the invention usable only by a “team” of operators (at minimum, one underwater controlling the housing and one on the surface controlling the recording device).

(ii) In U.S. Pat. Nos. 6,097,424 and 6,262,761, Zernov, et al, describe housings for video cameras that include a separate display screen inside the housing and lights mounted on the outside of the housing. This design fails to address the difficulties encountered in controlling the imaging system inside the housing.

(iii) In U.S. patent application Ser. No. 20020003584, Kossin describes a housing and non-mechanical control system for a specific digital camera. The housing is a hermetically-sealed “bubble” with a proximity switch to control a specific camera function. This control system includes a digital signal processor for converting the digital output of the camera to a radio signal and requires an RF modulator to communicate through the permanently-sealed housing. Unfortunately, this design is not transportable from one digital camera to another. Further, it requires destructive, physical changes to the camera, and requires that the “bubble” stay on the camera even when taking pictures on land.

All known housings suffer from, at least, three, distinct disadvantages:

(a) tight tolerances are required for mechanical coupling of activators to camera controls,

(b) housings are designed for use with only one camera, and

(c) housings can only be designed to work with cameras that already exist and cannot be adapted easily to new cameras.

### OBJECTS AND ADVANTAGES

In the world of analog photography where images are captured on a physical medium (such as 35 mm and medium-format filmstrips, or VHS, 8 mm, or other motion picture films), a photographer (professional or amateur) will commonly own only a small number of cameras. The photographer may obtain housings for each of these cameras, and will probably use these cameras and their housings for many years. In fact, the practical life span of many of these cameras is well over 20 years.

This is not the case with the digital recording technologies used in today's digital cameras. With respect to semiconductor theory (on which digital cameras are based), Moore's Law indicates that semiconductors will double in speed and capacity every 18 months. At this rate, today's digital cameras will be relatively obsolete in 12 to 18 months, replaced by smaller, faster alternatives. Current trends prove this out as camera manufacturers introduce cheaper, faster, more capable digital cameras every few months.

At the same time, while film cameras have been the mainstay for underwater photography for many years, digital cameras are now available that produce images rivaling those of film cameras. The images available from digital cameras will soon eclipse the resolution available from their analog counterparts. With this trend will come the need for new housings that support these digital cameras.

Primary Challenges

Thus, there are two primary challenges for producers of digital camera housings. These challenges relate to the usable life of digital cameras and the trend toward constant changes in camera design:

(i) The effective life span of any specific model of digital camera is very short.

Typically, housings for cameras are relatively expensive when compared to the cost of the camera. Camera owners were willing to spend this money for a camera and housing they would likely use for 10 to 20 years. But, in the digital camera market where the camera owner is likely to replace the camera after 18 months (we see this trend over and over again in the desktop computer market), buying a digital camera housing becomes a very expensive repeat purchase.

(ii) The cameras available today will probably be significantly redesigned within 12 months.

Digital camera manufacturers constantly add new features to and redesign their exiting offerings to stay competitive in a very competitive market. Thus, the time during which any given digital camera is marketable is significantly reduced. This fact, along with the large number of offerings in the digital camera market, forces housing manufacturers to make difficult decisions about which specific cameras are likely to be marketable long enough to justify the high cost of designing and producing a housing.

This controller addresses both of these primary challenges. Unlike the previously cited inventions, this controller uniquely provides the advantages of usability, upgradeability, adaptability, and generality.

(i) Usability

The controls on the outside of the housing can be programmed to invoke virtually any function of the camera (one button could invoke the ‘shutter release’ while another might change the color balance of the image). These controls would be customizable (either by replacing the controller system or via a computer program designed to change the mapping of the buttons to the camera's functions). This customization by owners would allow access to the features that each owner prized. For example, a professional underwater photographer may be interested in controlling aperture, shutter speed, and color balance while an amateur may only be interested in capturing basic images.

(ii) Upgradability

When a camera owner purchases a new camera, this controller can be upgraded to apply to both the new camera and the old and, thus, does not require the purchase of an entirely new housing.

(iii) Adaptability

An owner can employ the same housing for several cameras. For example, a scuba diver could execute a dive using her digital video (DV) camera and then execute a second dive using her digital still camera.

(iv) Generality

Housing manufacturers can build housings for specific purposes instead of for specific cameras. For example, one housing could be designed for the casual pool-goer or skin-diver (less expensive; not for rigorous application) whereas another could be created for recreational scuba divers (more rigorous) and still another for technical/professional divers (very rigorous).

Thus, this controller brings entirely new capabilities to owners of any digitally-controllable camera through usability, upgradability, adaptability, and generality.

### SUMMARY

In accordance with the present invention a non-mechanical imaging system controller (a “controller”) for hostile environments comprises a housing, a way of attaching and securing a camera, a non-mechanized system to control any camera, and a system to activate the controller.

### DRAWINGS

### Drawing Figures

In the drawings, closely-related drawings have the same number, but have different alphabetic suffixes.

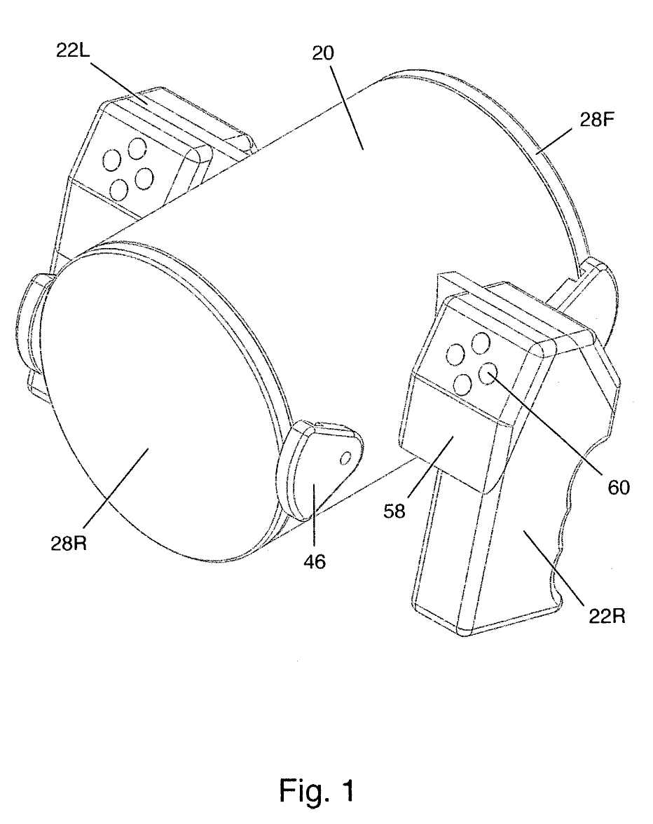

FIG. 1 shows general aspects of the exterior of the housing and the external activators.

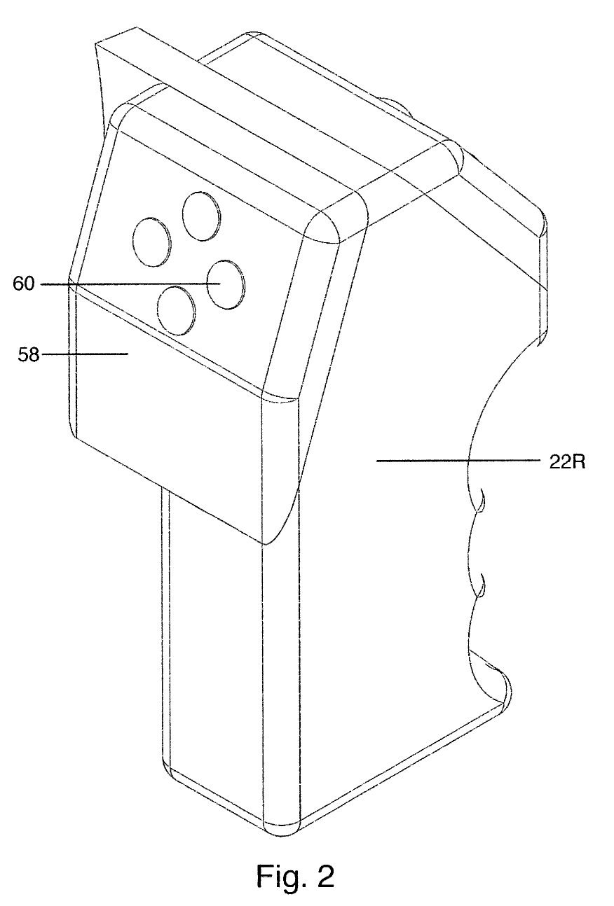

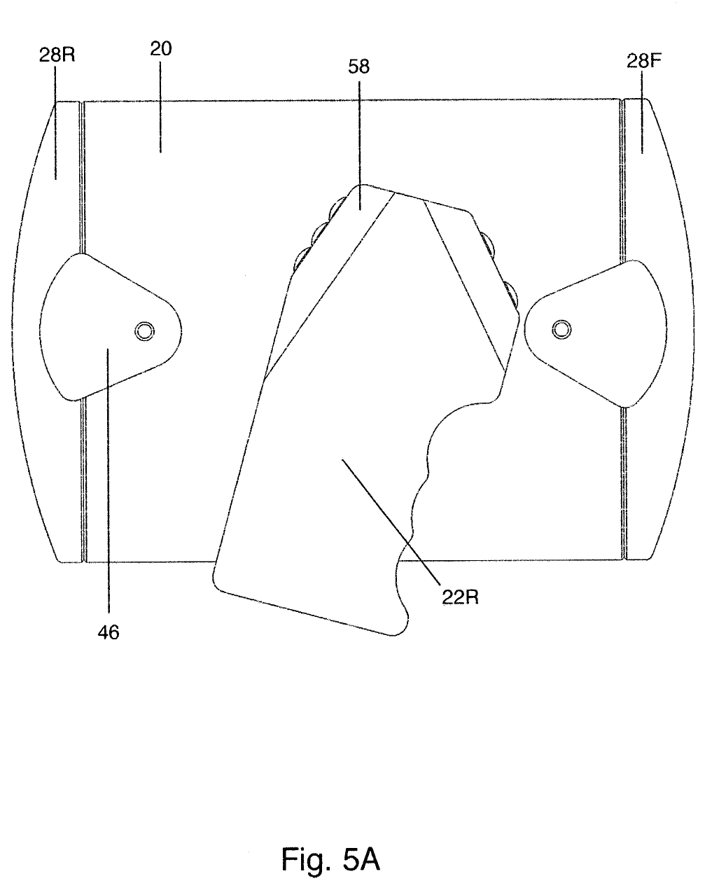

FIG. 2 shows the right side handle with an external activation assembly and buttons.

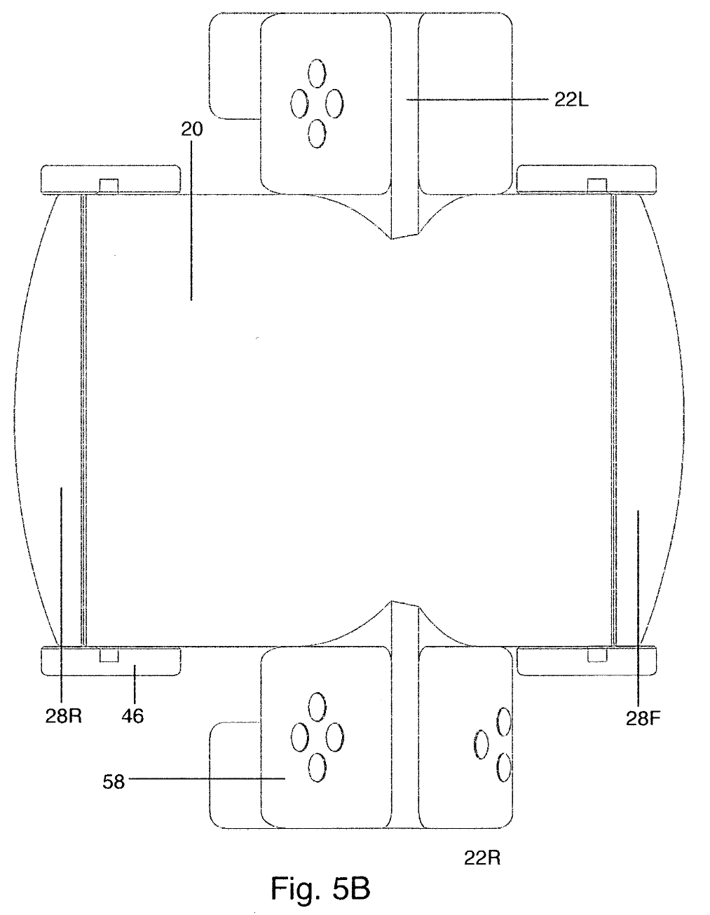

FIG. 5A shows an exterior, right side view of the housing and handle.

FIG. 5B shows an exterior, top side view of the housing and handles.

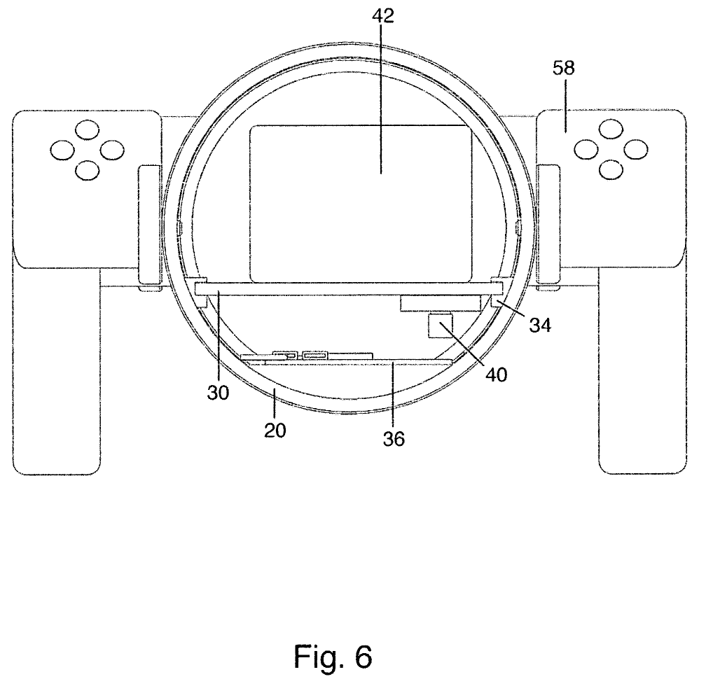

FIG. 6 shows an interior, rear view of the attachment mechanism and the controller.

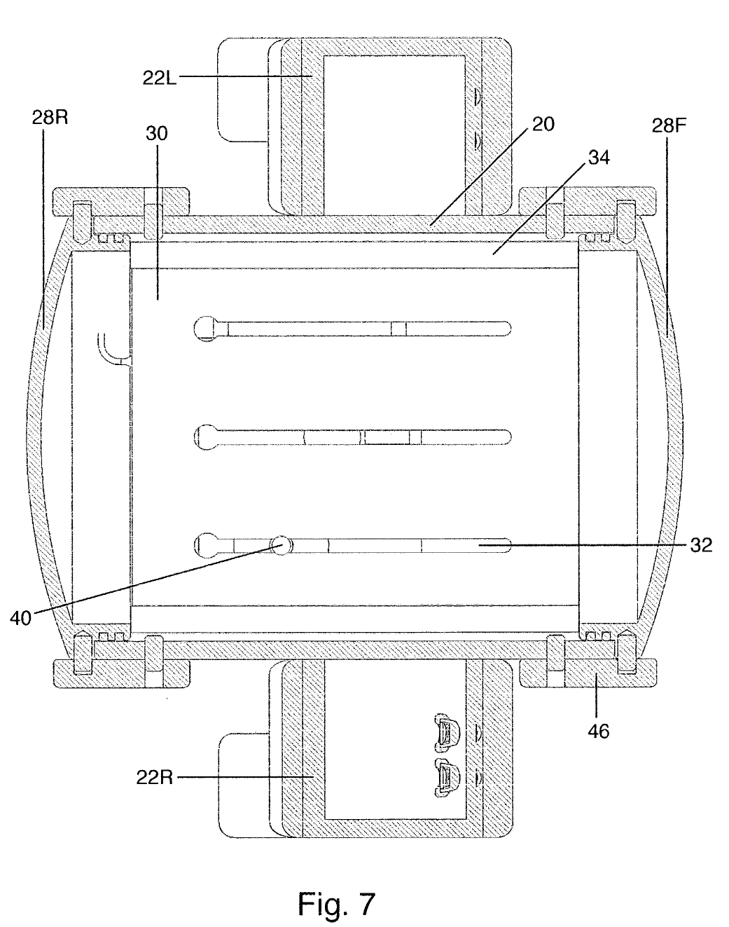

FIG. 7 shows an interior, top view cross-section of an attachment mechanism and platform.

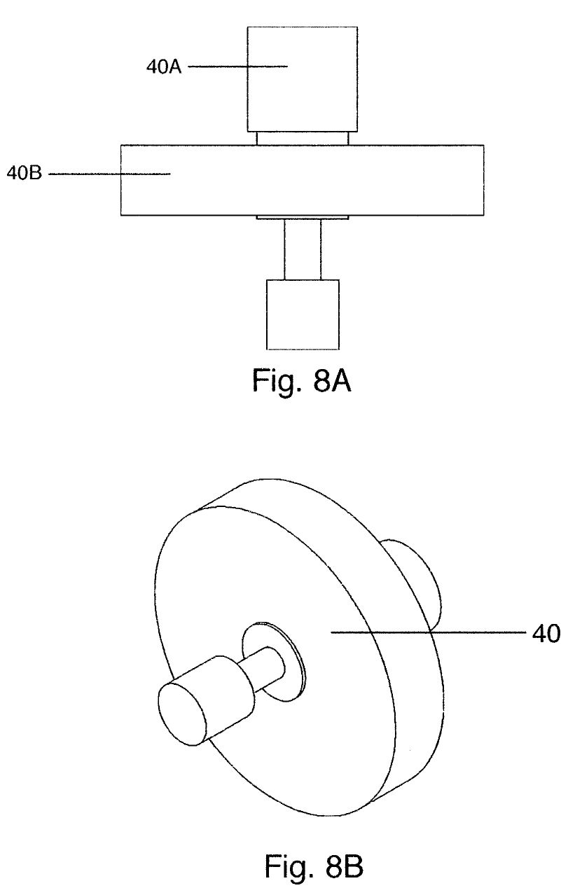

FIG. 8A shows a side view of an attachment mechanism.

FIG. 8B shows a side view of an attachment assembly.

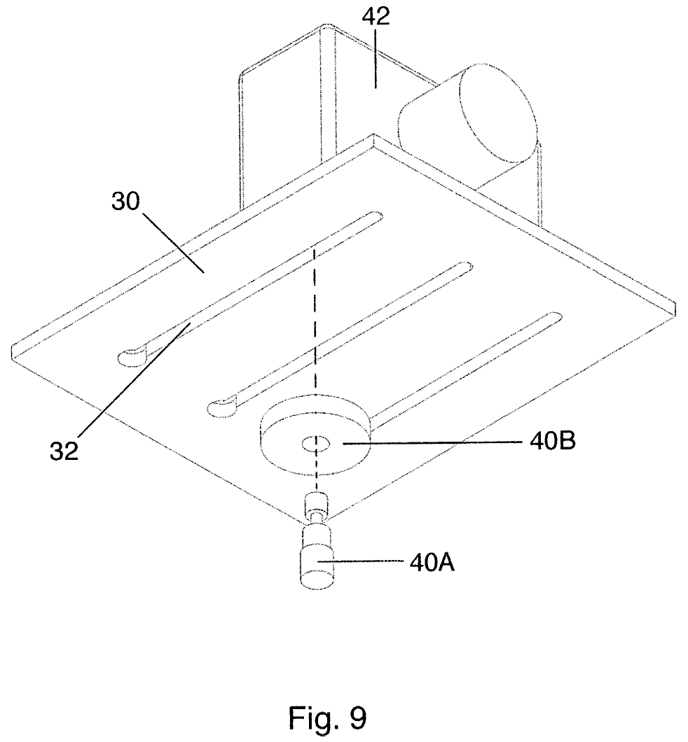

FIG. 9 shows the operation of the attachment assembly.

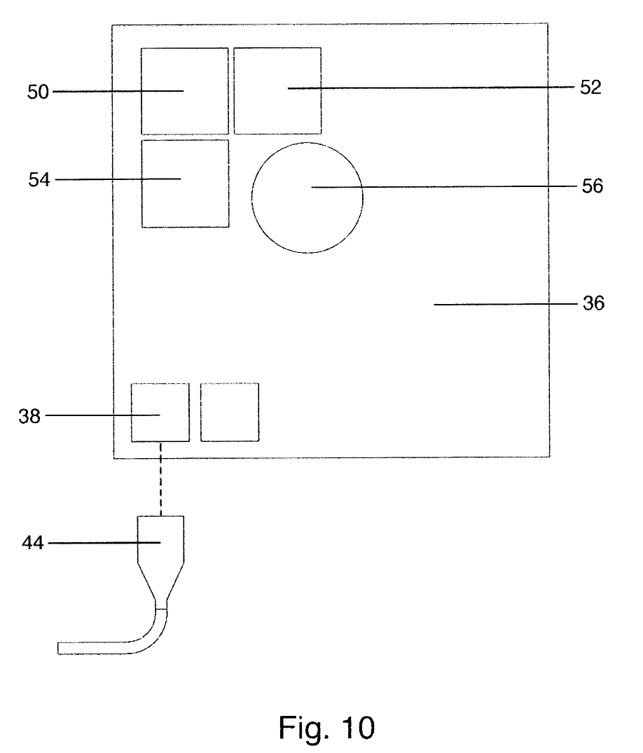

FIG. 10 shows various aspects of a controller.

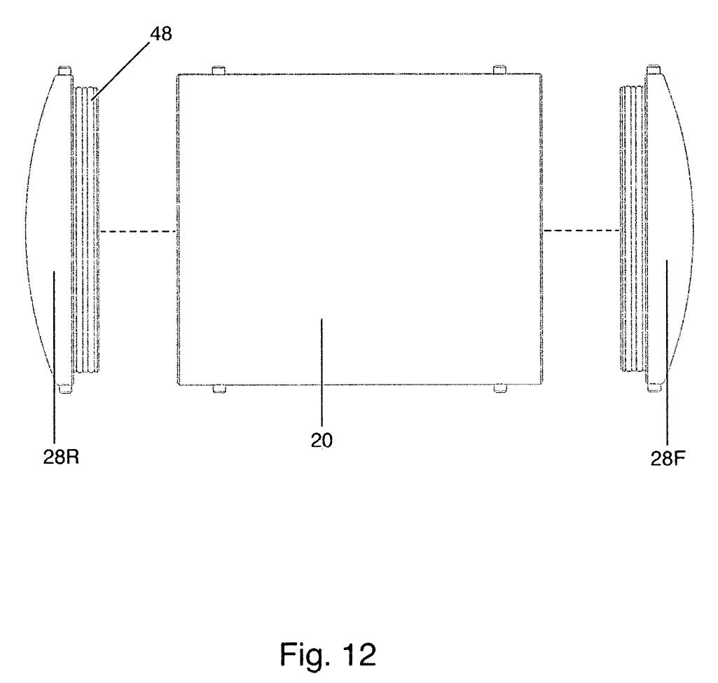

FIG. 12 shows the partial operation of the housing and lenses.

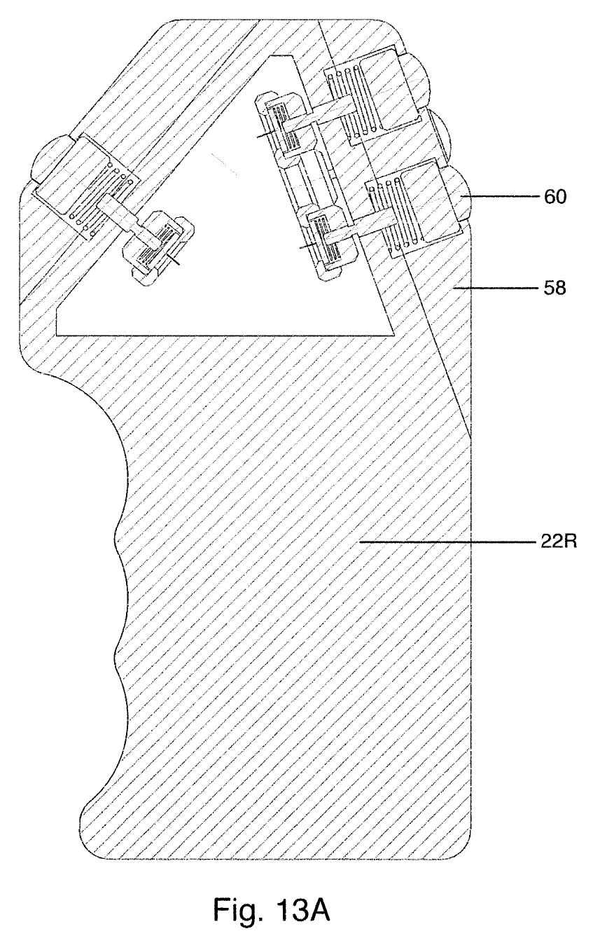

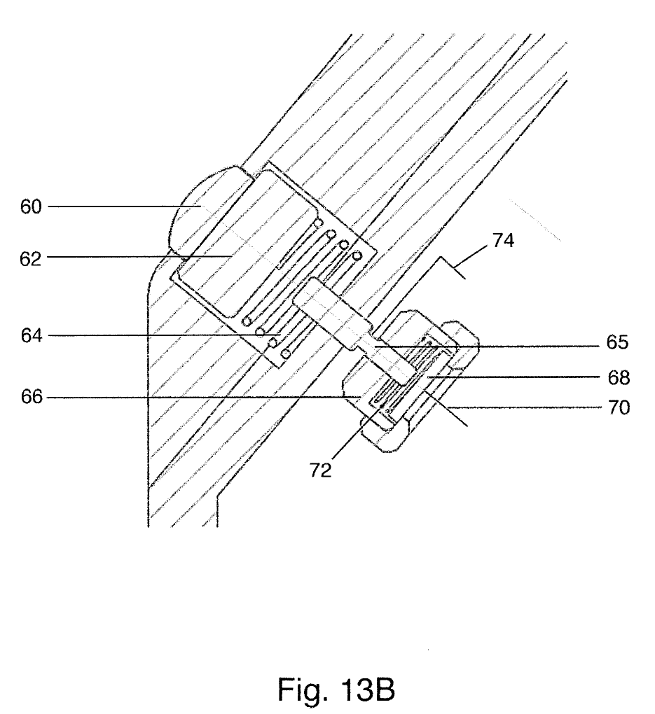

FIG. 13A shows a cross-section of the right side handle and external and internal activation assemblies.

FIG. 13B shows a cross-section and various details of an external activation assembly and an internal activation assembly.

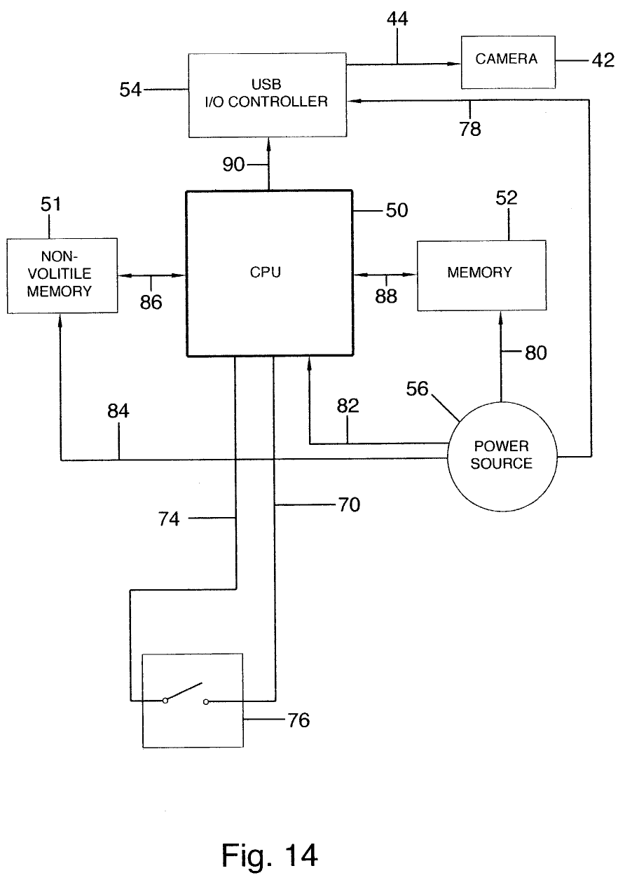

FIG. 14 is a block wiring diagram showing various aspects of communication between the components.

### REFERENCE NUMERALS IN DRAWINGS

20 housing

22 handles

22L left handle

22R right handle

28 lenses

28F front lens

28R rear lens

30 attachment platform

32 attachment platform horizontal adjustment slot

34 attachment platform rail

36 printed circuit board controller

38 universal serial bus cable connector

40 attachment assembly

40A attachment thumbscrew

40B attachment tightener

42 camera

44 universal serial bus cable

46 locking mechanism

48 0-ring

50 computer processor

51 nonvolatile memory

52 memory

54 input/output controller

56 power source

58 external activation assembly

60 button

62 ceramic magnet

64 external activation spring

65 activation pin

66 internal activation assembly

68 internal activation plate

70 internal activation lead

72 internal activation spring

74 internal activation lead

76 magnetic switch

78 power lead

80 power lead

82 power lead

84 power lead

86 nonvolatile memory lead

88 memory lead

90 controller lead

### DETAILED DESCRIPTION

Description—FIGS. 1, 5A, 5B, and 12—Housing Preferred Embodiment

A preferred embodiment of the housing of a controller is illustrated in FIG. 1 (right-rear view; Note: The described perspectives in this invention are from the perspective of a user of the controller. The “rear” is the side that faces the user while being operated.). A preferred housing 20 is cylindrical and hollow with a forged handle 22 on both the left 22L and right side 22R. On each of the handles 22 is an external activation assembly 58 containing 4 buttons 60. These buttons 60 are used to activate the various functions of the imaging system (camera) located within the housing. In the preferred embodiment, the housing would be of cylindrical aluminum with cutouts for the handles that would be welded in place over the cutouts. However, the housing could be constructed of any of a number of materials such as plastic or other metals and the shape could be ovular, square, or even shapeless. The only requirement for the housing is that it be sealable so that air and water will not be able to penetrate it. The material and shape chosen would depend on the intended application for this controller.

At each end of the cylindrical housing 20, FIG. 5 shows a convex lens 28 made of clear plastic. A front lens 28F and rear lens 28R allow the imaging system an unobstructed view to the outside of the housing and allow the operator to view the imaging system from the rear. However, the rear lens may not need to be transparent and the front and/or rear lenses may be flat. In addition, the lenses could be made of other materials, such as glass, as long as the material chosen is watertight (nonporous) and sealable against the rest of the housing. If a strong, transparent plastic were chosen for the housing 20, having separate, detachable lenses may be unnecessary.

Two locking mechanisms 46 appear on either side of each lens 28. After inserting the lenses 28, twisting the locking mechanisms 46 ensures that the lenses cannot accidentally come open during operation. Other embodiments intended for less rigorous application may not need locking mechanisms.

FIG. 12 shows the housing assembly with the front 28F and rear 28R lenses fitting into the ends of the housing cylinder. These lenses each have two O-ring seals 48 producing a watertight seal with the housing 20. While double O-ring seals are very common for sealing together discontinuous pieces, they are not the only way to seal the lenses to the housing. As mentioned earlier, either the front 28F or rear 28R lens could be a continuous piece with the housing itself, eliminating the need for a seal of any kind.

Those skilled in the art of underwater housing design will recognize the housing design used here, the use of double o-ring seals as well as the use of locking mechanisms as written.

FIGS. 6, 7, 8A, 8B, and 9—Attachment Preferred Embodiment

A preferred embodiment of the attachment mechanism of the controller is illustrated in FIG. 6 (rear view). This figure shows an attachment assembly 40 protruding through an attachment platform 30 and into the tripod mount on the bottom of a camera 42. (Practically every camera, digital or otherwise, has a tripod-mounting socket on the bottom of the camera.) Two attachment platform rails 34 on either side of the housing secure the platform 30 during use.

FIG. 7 (top view; cross-section) shows three attachment platform horizontal adjustment slots 32 in the attachment platform 30 and its position within the housing 20. The platform 30 is secured to the housing by sliding the platform into the rails 34 permanently secured to the housing 20. The three slots 32 run nearly the length of the platform 30 and serve to allow forward/rear and side-to-side positioning of the camera relative to the center of the front lens 28F. This design will accommodate cameras with tripod mounts in the center, on the left side, or on the right side of the bottom of the camera. In addition, it allows room for the addition of accessories to the camera (for example, an attached wide-angle lens or a macro flash).

FIG. 8A shows the assembled attachment assembly 40 from the side. The assembly consists of two pieces, an attachment thumbscrew 40A capped with standard tripod screw threads for attachment to the camera, and an attachment tightener 40B used to provide a tighter attachment for the camera, keeping the camera in place during use. FIG. 8B shows a top-side view of the same, assembled, attachment assembly 40 and serves primarily to further describe the shape of the assembly to the reader.

FIG. 9 shows the full assembly for the attachment mechanism, showing the thumbscrew 40A going through the tightener 40B, through the platform 30, and into the tripod socket on the bottom of the camera 42.

While the attachment mechanism illustrated here is the preferred embodiment, there are other mechanisms by which the camera could be attached. For example: the housing could be sized and shaped to fit a specific camera which would hold the camera in place, lanyards could be used to secure the various facets of the camera, inflatable plastic pouches could be inserted into the housing to keep the camera in place, or a sculpted piece of foam could be inserted to hold the camera.

Those skilled in with the art of tripod design will recognize the materials and design of the preferred attachment assembly 40 and platform 30.

FIGS. 2, 13A, and 13B—Activation Assembly Preferred Embodiment Two separate subassemblies, the external activation assembly and the internal activation assembly, work together to provide the composite function of the activation assembly. A preferred embodiment of this activation mechanism (the “activator”) of the controller, illustrated in FIG. 2 (right side view) shows the right-side handle 22R with the external activation assembly containing four buttons 60 used to activate some of the camera's various functions. (More buttons appear on the other handle 22L shown in FIGS. 1, 5B, and 6.)

FIG. 13A shows a cross-section of the entire handle 22R and the activation assemblies.

FIG. 13B shows a cross-section and specific details of the external activation assembly and the internal activation assembly. Each button 60 rests atop a ceramic magnet 62 held in place by an external activation spring 64. When depressed, the magnet 62 makes contact with an activation pin 65, magnetizing an internal activation assembly 66. The assembly 66 contains a magnetically-sensitive internal activation plate 68 supported by an internal activation spring 72. When once magnetized, the assembly 66 acts as an electrical switch providing a continuous circuit between two internal activation leads 70 and 74.

While the preferred embodiment shows eight buttons 60 facing rearward and 3 buttons forward, the number and size of these buttons are rather arbitrary and their arrangement a matter of convenience. While the controller requires an external activation assembly, it does not require handles 22 at all. Handles simply assist with the overall usability of the controller.

In this preferred embodiment, the buttons contain a ceramic magnet strong enough to close a switch mounted on the inside of the handle 22, producing an electrical input signal for the controller mechanism through an electrical wire connected to the controller. The primary purpose of the activator is to provide an input to the controller mechanism. Other embodiments could have buttons or switches that were not magnetic, differed in size, shape, and number, and could even have mechanical connections to the inside of the housing. Other embodiments could include infrared or radio-frequency activators mounted inside or outside of the housing as a mechanism for providing input to the controller. None of these changes would alter this controller materially. Even the addition of mechanical connections to the inside of the housing would not alter this controller as this mechanical connection would only serve as a way to provide an electrical input into the controller, not as a way of activating a button or other activatable component of the camera.

Those skilled in the art of electrical switch design will recognize the use of activation mechanisms using magnetic switches as described.

FIGS. 6, 10, and 14—Controller Preferred Embodiment

A preferred embodiment of the controller mechanism of the controller, illustrated in FIG. 10 (view from above), shows a printed circuit board controller 36. Integrated into this controller 36 are a computer processor 50, memory 52 and nonvolatile memory 51, an input/output controller 54, and a power source (battery) 56. The nonvolatile memory 51 retains, at least, two lookup tables: one table relates inputs from each internal activation assembly to a specific function of the camera, a second table relates a specific function of a given camera to the control codes to transmit to the camera in order to invoke the specific function. The memory 52 is used by the processor 50 as a normal part of operation. A universal serial bus cable 44, the other end of which is plugged into the camera, plugs into the controller via a universal serial bus cable connector 38.

FIG. 14 shows the basic wiring schematic used in the preferred embodiment of the controller. The power source 56 provides power for this controller mechanism and to the various components of the controller via four power leads 78, 80, 82, and 84. Several leads, a nonvolatile memory lead 86, a memory lead 88, and a controller lead 90, facilitate communication between the processor 50 and the nonvolatile memory 51, the memory 52, and the I/O controller 54, respectively. A magnetic switch 76 represents the switch functionality provided by the internal activation assembly 66 as described above.

The I/O controller 54 in the preferred embodiment includes a universal serial bus (USB) controller, the most common protocol for communicating with cameras. In addition to USB, digital video (DV) cameras often use IEEE-1394 (also known as “FireWire”) protocol controllers for communicating with electronic devices. An emerging, radio-frequency (RF) communications standard named “Bluetooth” has recently been incorporated into some cameras, as well. Any of these individual I/O protocol controllers (or any combination of them) could be incorporated into the controller 36 as a way to communicate with more types of cameras. Any new standards for communicating could be incorporated as well. Incorporating many standards for communication figures prominently in the controller's ability to generically support many different types/brands of cameras.

FIG. 6 shows the relative positioning of the controller 36 within the housing.

Those skilled in the art of integrated circuit design will recognize the use of processors, memory, and power supplies. Those skilled in the arts of electronic communications protocols and circuit design will recognize the use of USB and other communications protocols (protocol specifications are available from virtually all digital camera manufacturers). Those skilled in the arts of embedded-systems programming and general computer programming will recognize the use of lookup tables and their application here.

Advantages

The combination of a generalized housing, standard electrical or electromechanical activators, a common attachment mechanism, and a specialized I/O controller makes this controller more than the sum of its parts.

The generalized housing and activators are simple to manufacture and can be used over and over with different makes, models, and types of cameras.

The attachment mechanism is also easy to manufacture and will be immediately recognized by almost all users of the controller.

The controller is replaceable and therefore adaptable to new communications protocols used by new cameras. In addition, the controller and activation tables are programmable so that any new model of camera could be supported.

Operation—FIGS. 1, 2, 6, 9, 10, 12, 14

Operation of the controller should be straightforward to most users of digital cameras and underwater housings.

FIG. 9 shows the thumbscrew 40A being placed through the tightener 40B, through a slot 32 in the platform 30, and screwed into the camera's tripod mount. Slide the camera forward in the slot 32 until the leading edge of the camera lens is near the edge of the platform 30 and tighten the tightener 40B to secure the camera. Plug one end of the USB cable 44 into the camera 42.

Slide the platform 30 into the housing 20 between the two platform rails 34 shown in FIG. 6.

Plug the other end of the USB cable 44 into the universal serial bus cable connector 38 shown in FIG. 10.

Stretch the two “0-ring” seals 48 around each of the lenses 28 as shown in FIG. 12 and insert the front lens 28F and rear lens 28R into the housing 20. Twist the locking mechanisms 46 in FIG. 1 to secure the lenses 28.

Once the previous operational steps have been performed, grip the housing by the left 22L and right 22R handles shown in FIG. 1, point the front lens 28F toward the subject to be captured and look through the rear lens 28R to view the subject as the camera sees the subject. Depress the buttons 60 shown in FIGS. 1 and 2 to activate functions of the camera (such as the shutter-release to capture the image).

When activated by depression of one of the buttons 60, the internal activation assembly 66 closes the magnetic switch 76 illustrated in FIG. 14 and sends a signal to the computer processor 50. The processor 50 looks up the camera function to activate in the nonvolatile memory 52 and the control codes used to invoke the function. The control codes, relayed through the I/O controller 54 to the camera 42, execute within the camera (for example, actually taking the picture).

Some embodiments may not need the use of multiple lenses. Other embodiments may need mechanisms other than a USB cable to communicate with the camera. Some embodiments will require other mechanisms for securing the camera as detailed in the previous sections.

Conclusion, Ramifications, and Scope

This housing and controller for taking pictures under water or in other hostile environments provides a usable, upgradeable, adaptable, and general solution for photographers of any skill level. Additionally, this controller works with all controllable cameras in a generic fashion and provides tremendous value over all current offerings.

While my above description contains many specificities, these should not be construed as limitations on the scope of this controller, but as merely providing illustrations of some of the presently preferred embodiments of it. Many other variations are possible.

For example, the printed circuit board controller is shown as one component, but could be designed as distributed components attached to the activators; the activator/controller combination may be a freestanding remote control device (for example, like the keyless entry system for an automobile or a virtual reality glove) and does not need to be physically attached to the housing; the housing may be made of many different materials such as aluminum, steel, plastic, glass, etc.; the housing may be in many different shapes such as cylindrical, ovular, trapezoidal, etc.; the lenses may be made of any one of many translucent materials such as glass, plastic, etc.; the lenses may be curved or flat; the processor/memory combination may be replaced by some in-circuit design; any combination of communications protocols could be incorporated into the design including those not yet conceived; my controller is equally applicable to virtually all digital cameras and digital video cameras, as well as some non-digital cameras; many attachment mechanisms have been invented that could be used to secure the imaging system; power for the printed circuit board controller could be provided by the camera instead of being mounted on the controller, etc.

Thus, the scope of the invention should be determined by the appended claims and their legal equivalents, rather than by the examples given.

I claim:

1. An imaging system, comprising:
(a) a housing with one or more openings, impervious to hazardous elements when said housing and said openings are sealed,
(b) an attachment mechanism,
(c) a non-mechanical controller, and
(d) an activator outside said housing.

2. The imaging system of claim 1 wherein said non-mechanical controller contains control codes for one or more camera models.

3. The imaging system of claim 2 wherein said non-mechanical controller utilizes modifiable maps of activators to camera functions.

4. The imaging system of claim 3 wherein said non-mechanical controller utilizes modifiable maps of camera functions to control codes.

5. The imaging system of claim 1 wherein said non-mechanical controller requires no modifications to an attached camera.

6. The imaging system of claim 2 wherein said housing is shaped to work with more than one make or model of camera.

7. The imaging system of claim 6 wherein said camera attachment mechanism accommodates a camera when said camera is used with accessories that change the size or shape of said camera.

8. An imaging system, comprising:
(a) a housing impervious to hazardous elements when said housing is sealed,
(b) an attachment means for securing a camera inside said housing,
(c) a controller means for communicating with and invoking functions of said camera without the use of mechanical connections, and
(d) an activation means outside said housing for stimulating said controller.

9. The imaging system of claim 8 wherein said controller means can control one or more types of cameras through the use of multiple sets of camera control codes.

10. The imaging system of claim 8 wherein said controller means requires no physical modifications to said camera.

11. The imaging system of claim 8 wherein said controller means can be adapted by the operator to invoke those functions of said camera desired by the operator through the use of maps of activators to camera functions.

12. The imaging system of claim 11 wherein said controller means supports multiple types of cameras through the use of modifiable maps of camera functions to control codes.

13. The imaging system of claim 9 wherein said housing is shaped to work with multiple sizes and shapes of cameras.

14. The imaging system of claim 13 wherein said attachment means accommodates a camera when said camera is used with accessories that change the size or shape of said camera.

15. A method for remotely controlling an imaging system when said imaging system is protected from a hostile environment and physical access to said imaging system is denied, comprising:
(a) storing a control code association map associating a control code with an invokable function of said imaging system,
(b) storing a signal association map associating a specific input signal with said control code,
(c) receiving a signal from said hostile environment through an activator,
(d) looking up said invokable function in said signal association map using said specific input signal,
(e) looking up said control code in said control code association map using said invokable function,
(f) transferring, non-mechanically, said control code to said imaging system causing said invokable function to be executed,
whereby said invokable function of said imaging system can be invoked, without the use of mechanical aids, despite said imaging system being unavailable for physical access, and
whereby a photographer may stimulate said invokable function while physically located within said hostile environment.
